(19) United States
(12) Patent Application Publication
(10) Pub. No.: US 2005/0252013 A1
(43) Pub. Date: Nov. 17, 2005

(54) Device for extracting particles from liquid

(76) Inventor: Leo James Stocco, Vancouver (CA)

Correspondence Address: Leo Stocco, 404 - 2370 W. 2nd Ave., Vancouver, BC, V6K 1J2, CA

(21) Appl. No.: 11/121,286

(22) Filed: May 3, 2005

Related U.S. Application Data
(60) Provisional application No. 60/570,044, filed on May 12, 2004.

(51) Int. Cl. C12C 7/14

(52) U.S. Cl. 30/402

(57) ABSTRACT

A tool for easily removing solid particles from liquid. The particle remover comprises a handle (22), a distal surface (26) and a member array (24) comprised of a plurality of elongated members (28) that are arranged such that the elongated members (28) and the distal surface (26) define an open ended chamber (38) that is open on one end for trapping particles. The particle remover can be used to selectively remove particles that are either floating or submerged in a liquid without substantially disturbing the liquid and can be used repeatedly to accumulate particles that are dispersed throughout the liquid.

### CROSS-REFERENCE TO RELATED APPLICATIONS

This application claims the benefit of provisional patent application Ser. No. 60/570044, filed 2004 May 12 by the present inventor.

### FEDERALLY SPONSORED RESEARCH

Not Applicable

### SEQUENCE LISTING OR PROGRAM

Not Applicable

### BACKGROUND OF THE INVENTION

1. Field of Invention

This invention provides a means of easily removing foreign particles that are floating or submerged in a liquid.

2. Prior Art

Often times, undesired, small foreign particles are found floating in a beverage. For example, bits of cork may break off when a bottle of wine is opened and appear floating in one's wine glass, stray coffee grounds appear floating in one's coffee cup, or tea leaves escape a flawed tea bag and appear floating in one's tea cup.

Common methods for removing these unwanted particles include straining the beverage through a filter or strainer, scooping the particles out using a utensil such as a spoon or a knife, or picking the particles out using one's finger. Straining the beverage is time consuming, messy, may adversely affect the temperature or taste of the beverage, may be difficult with viscous beverages and may simultaneously remove other desired elements from the beverage, such as fruit pulp. Scooping the unwanted particles out with a spoon or knife is often difficult, particularly when the particles are submerged, and may require one to discard a portion of the beverage with each scoop. This may be undesirable when the beverage is expensive such as fine wine. Using one's finger to pick particles out of a beverage is unsanitary and may be socially unacceptable, particularly when removing particles from someone else's beverage. It may also be dangerous to use one's finger if the beverage is very hot such as a fresh cup of coffee.

In addition to the standard strainers and filters used in food preparation, inventors have created specialized strainers and traps for removing sediment from wine such as U.S. Pat. No. 6,260,474 (2001), U.S. Pat. No. 5,616,242 (1997) and U.S. Pat. No. 5,417,860 (1995). All three of these inventions are inserted into a wine bottle and trap sediment or other debris as the wine is being poured into a glass. In addition to the disadvantages of strainers mentioned above, these devices must be placed in the wine bottle before the wine is poured. Since it is difficult to see cork particles in a colored wine bottle which may also have a label on it, it is often not known that they are present until after the wine has been poured into a glass. Once the wine has been poured, it is too late to use the devices mentioned above.

The U.S. Pat. No. 5,199,349 (1993) is used to skim foreign material from the surface of a liquid. This device wastes a substantial portion of liquid with each deployment and cannot be used to remove particles that are submerged.

A plurality of devices exist that use extruding members to mate with and hold a secondary object. In U.S. Pat. No. 6,588,073 (2003), U.S. Pat. No. 6,357,088 (2002), U.S. Pat. No. 5,983,467 (1999), U.S. Pat. No. 5,845,375 (1998), U.S. Pat. No. 5,702,797 (1997), U.S. Pat. No. 5,657,516 (1997), U.S. Pat. No. 5,572,773 (1996), U.S. Pat. No. 5,555,608 (1996), U.S. Pat. No. 5,067,210 (1991), U.S. Pat. No. 5,058,247 (1991), U.S. Pat. No. 4,980,003 (1990), U.S. Pat. No. 4,707,893 (1987), U.S. Pat. No. 4,646,397 (1987), U.S. Pat. No. 4,198,734 (1980), U.S. Pat. No. 4,180,890 (1980) and U.S. Pat. No. 3,943,981 (1976), members can be found in the shapes of hooks, loops, mushrooms, nibs, ridges, spikes, fibres, hairs, claws, posts and textured surfaces. The devices are specifically designed to mate with objects or surfaces that also have a very specific design. These include loops or fibres, hairs, hooks, ridges, threads or wires, magnets or magnetic material. These devices use a variety of different means to form a physical bond which include hooking a loop, impaling, interlocking, magnetism and friction.

However, these members are not designed to adhere to particles of arbitrary shape, size and material.

### BACKGROUND OF THE INVENTION—OBJECTS AND ADVANTAGES

The objects and advantages of the present invention are that:
(a) the present invention provides the ability to easily extract particles that are either floating or submerged in a liquid;
(b) the present invention provides the ability to extract particles of various shapes, sizes and materials from a liquid;
(c) the present invention provides the ability to extract particles from a liquid without transferring the liquid from its original vessel; and
(d) the present invention is small, slender, portable and convenient to carry in a sleeve or shirt pocket.

### SUMMARY

In accordance with the present invention, a particle remover comprises an elongated handle with a distal surface and a member array comprising a plurality of elongated members that are arranged such that the elongated members and the distal surface define an open ended chamber that traps particles as it penetrates a liquid. The particle remover can be used to remove particles that are either floating or submerged and are of various size, shape or material from a liquid without substantially disturbing the liquid or transferring the liquid to a secondary vessel. It can be used repeatedly to accumulate particles that are dispersed throughout the liquid and is portable enough to carry in a shirt pocket or purse.

In the drawings, closely related figures have the same number but different alphabetic suffixes.

### DRAWINGS—FIGURES

Further objects and advantages will become apparent from a consideration of the ensuing description and drawings.

FIG. 1 is an environmental perspective view illustrating the particle remover in a position to be operated, and showing its general features.

FIG. 2A is a perspective view of the particle remover.

FIG. 2B is an elevation view of the front of the particle remover.

FIG. 2C is a detailed perspective view of the particle remover showing details of its member array.

FIG. 2D is a detailed elevation view of the distal end of the particle remover showing details of its member array.

FIG. 3 is a detailed perspective view of the distal end of the particle remover showing details of an alternate embodiment of its member array.

FIG. 4 is a detailed perspective view of the distal end of the particle remover showing details of a second alternate embodiment of its member array.

FIG. 5 is a detailed perspective view of the distal end of the particle remover showing details of a third alternate embodiment of its member array.

FIG. 6 is a detailed perspective view of the distal end of the particle remover showing details of a fourth alternate embodiment that comprises a plurality of separate spaces and openings instead of a member array.

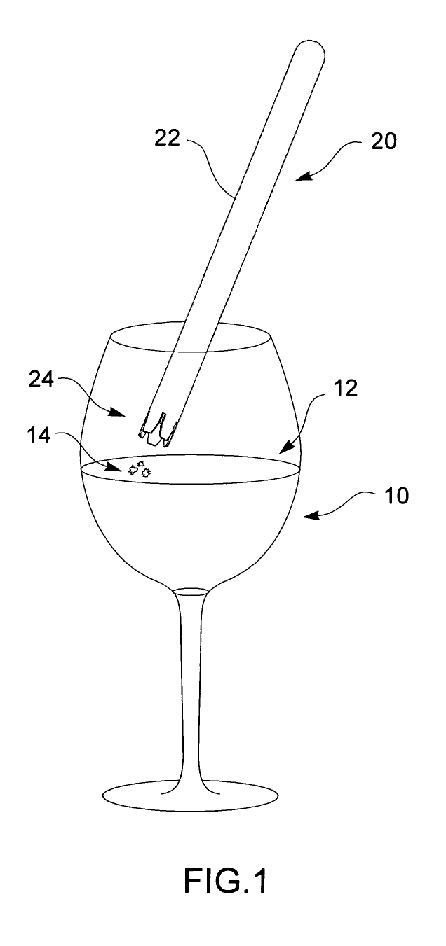

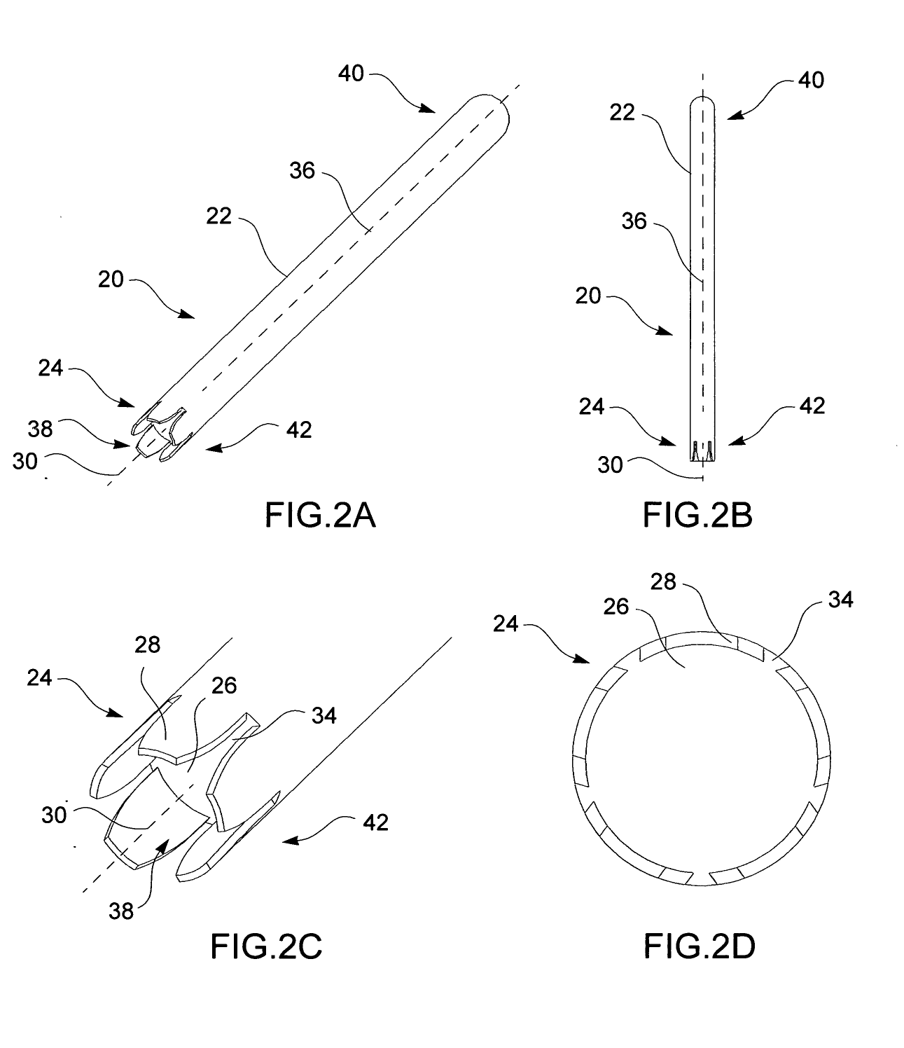

### DETAILED DESCRIPTION—FIGS. 1, 2A, 2B, 2C, 2D—PREFERRED EMBODIMENT

A preferred embodiment of the present particle remover is illustrated in FIG. 1 (environmental perspective view), FIG. 2A (perspective view), FIG. 2B (front view), FIG. 2C (detailed perspective view) and FIG. 2D (bottom view). The particle remover 20 essentially comprises an elongated handle 22 with a distal surface 26 and a member array 24 which is comprised of a plurality of elongated members 28 which are separated by gaps 34 such that the distal surface 26 and member array 24 cooperate to define an open ended chamber 38. The open ended chamber 38 has a chamber axis 30 which is substantially parallel to the longitudinal axis 36 and an opening which is on the distal end 42 and substantially transverse to the longitudinal axis 36 of the particle remover. In the preferred embodiment, the particle remover is made from stainless steel. However, the particle remover can be made from a variety of other materials such as wood, plastic, glass, rubber, carbon fibre, aluminum, etc.

In the preferred embodiment, the handle 22 is a cylinder with circular cross sections and is rounded on the proximal end 40 of the particle remover. However, the handle 22 may have any shape and texture that is attractive, can be held firmly and comfortably and which makes it convenient to reach the member array 24 into a vessel such as a drinking glass 10 or bottle.

In the preferred embodiment, the distal surface 26 is substantially transverse to the longitudinal axis 36 but the distal surface 26 may be oriented at any angle to the longitudinal axis 36 to improve the appearance or ergonomics of the particle remover. In the preferred embodiment, the distal surface 26 is essentially flat but it may also be concave, convex, etc., to improve the appearance of the particle remover or to increase the surface area of the distal surface 26. In the preferred embodiment, the distal surface 26 is essentially round in shape but it may also be square, oblong, elliptical, triangular etc. The circumference of the distal surface 26 is typically 20 mm to 50 mm.

Connected to the distal surface 26 is a member array 24 comprised of a plurality of elongated members 28. In the preferred embodiment, each elongated member 28 is substantially parallel to the longitudinal axis 36. However, the elongated members 28 could be oriented at any angle to the longitudinal axis 36 to improve the appearance or ergonomics of the particle remover. In the preferred embodiment, each elongated member 28 has a cross section that is approximately 6 mm wide and 0.5 mm thick. Each elongated member 28 is approximately 11 mm long and conforms to the outer curvature of the distal surface. However, the elongated members 28 can have different cross sections, such as round, square, oval, triangular, etc., which may also vary in size and shape along the length of the elongated member 28. The individual elongated members 28 in the member array 24 may also have different cross sections and lengths from one another.

The member array 24 must be arranged so that the elongated members 28 and the distal surface 26 cooperate to define an open ended chamber 38 that is open on the distal end 42 of the particle remover and where the chamber opening is substantially transverse to the longitudinal axis 36. The member array 24 must comprise a minimum number of three elongated members 28 which are positioned along a closed path such that the distal surface 26 and the member array 24 together define an open ended chamber 38 that is open on the distal end 42. Additional elongated members 28 may also be positioned inside the open ended chamber 38. In the preferred embodiment, five elongated members 28 are arranged in a circular pattern to define a cylindrical open ended chamber 38 that contains no internal elongated members. In the preferred embodiment, the chamber axis 30 is aligned with the longitudinal axis 36 to facilitate insertion into a vessel. The gaps 34 between elongated members 28 (see FIGS. 2A, 2B, 2C and 2D) must be large enough to allow air to escape and liquid to flow through the open ended chamber 38 when liquid is forced into the open end of the open ended chamber 38 as the particle remover is plunged into the liquid, but small enough to inhibit liquid from flowing through the open ended chamber 38 when liquid is not being forced into the open end of the open ended chamber 38 as the particle remover is removed from the liquid. In the preferred embodiment, the gaps 34 are approximately 1 mm wide at the base and 4 mm wide at the tip.

Operation—FIG. 1

The manner of using the particle remover to remove a group of cork particles 14 from a drinking glass 10 partially filled with liquid 12 is illustrated in FIG. 1. The particle remover is moved along a path parallel to the longitudinal axis 36 such that the distal end 42 of the particle remover is plunged into the particles 14 thereby encompassing the particles 14 inside the open ended chamber 38. As the particle remover penetrates the liquid 12, liquid is forced into the open ended chamber 38 through the chamber opening and passes out of the open ended chamber 38 through the gaps 34 between the elongated members 28, thereby allowing the particles that are suspended in the liquid to enter the open ended chamber 38 and come into contact with either the distal surface 26 or the member array 24. The particles 14 become adhered to the particle remover by a thin layer of liquid that exists between the particle remover and the particles. The particle remover is lifted from the liquid 12 in a direction opposite to that in which it entered the liquid. When the particle remover is being withdrawn from the liquid, liquid is not forced into the open ended chamber 38 and the member array 24 inhibits the liquid that is flowing past the particle remover from entering the open ended chamber 38 so there is much less fluid flow through the open ended chamber 38 than there is when the particle remover is penetrating the liquid. Consequently, the particles 14 are prevented from being dislodged from the particle remover as the particle remover is withdrawn from the liquid. The particles 14 remain adhered to the particle remover and are thereby removed from the liquid along with the particle remover.

Once a group of particles have been removed using the particle remover, subsequent groups of particles can be removed by employing the particle remover in exactly the same manner. Particles that are already adhered to the distal surface 26 or member array 24 during prior deployments of the particle remover typically remain adhered during subsequent deployments of the particle remover.

The particle remover works because of a well known property of liquids called surface tension. Surface tension causes certain liquids known as wetting liquids to adhere to solid surfaces. Many common liquids such as water, wax and oil are wetting liquids. The particle remover will only work if the liquid is a wetting liquid such as a beverage. It will not work if the liquid is not a wetting liquid such as mercury.

When the particle remover is plunged into a group of particles 14, the particles 14 become submerged and surrounded by the member array 24 and the distal surface 26. As the particle remover penetrates the liquid, liquid flows out through the gaps 34 between the elongated members 28 and the particles are pressed up against either the member array 24 or the distal surface 26. When a particle is pressed up against any part of the particle remover, the thin layer of liquid that separates the particle from the particle remover simultaneously adheres to both the particle and the particle remover thereby forming a bond between the particle and the particle remover. Once particles become adhered to the interior of the open ended chamber 38 of the particle remover, the member array 24 provides a barrier between those particles and the liquid that flows past the particle remover as the particle remover is withdrawn from the liquid. The member array 24 thereby prevents the adhered particles from becoming dislodged when the particle remover is removed from the liquid. Since the presence of liquid is instrumental in the operation of the particle remover, the particle remover can be used to remove particles that are either floating or submerged.

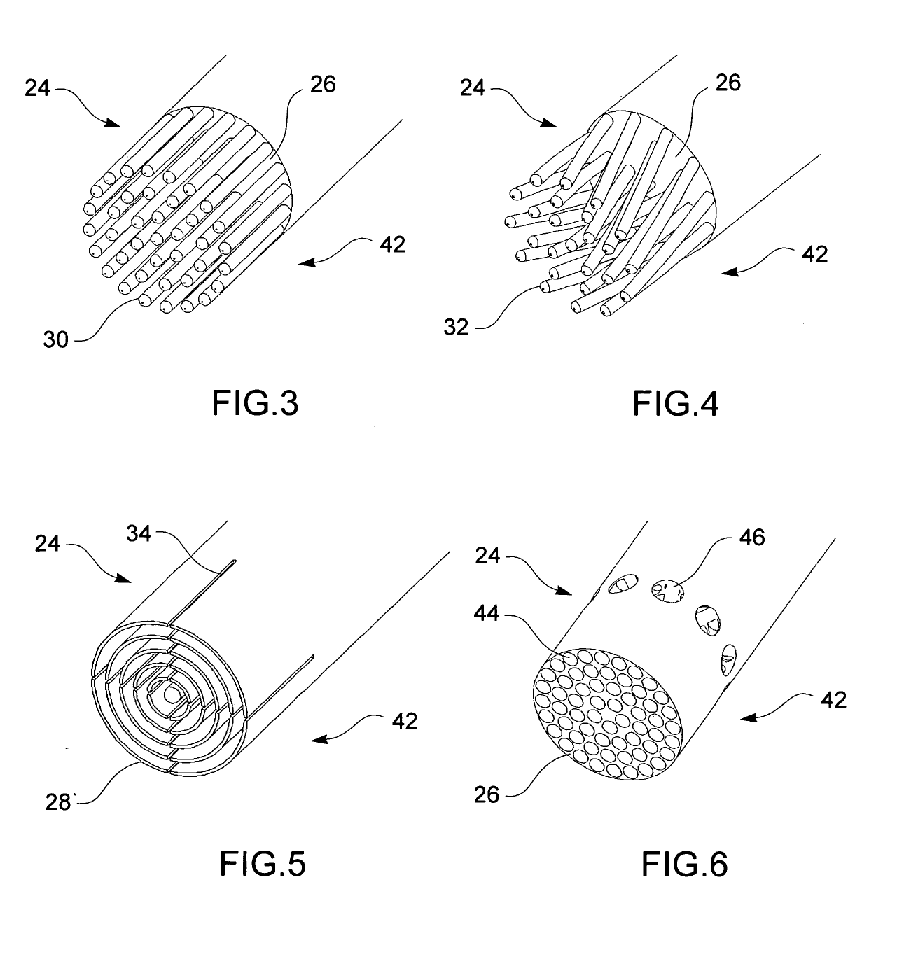

FIGS. 3-5—Additional Embodiments

Additional embodiments of the member array 24 are shown in FIGS. 3, 4 and 5; in each case a detailed perspective view of the member array 24 is shown. In FIG. 3, the elongated members 30 are straight, narrow, cylinders which are all parallel to one another and where the open ended chamber contains additional elongated members. In FIG. 4, the elongated members 32 are curved, narrow, cylinders which are all oriented at various angles to one another and where the open ended chamber contains additional elongated members. In FIG. 5, the elongated members 28 are straight, of varying widths and are all parallel to one another and where the open ended chamber contains additional elongated members.

FIG. 6—Additional Embodiments

An additional embodiment of the distal end of the particle remover is shown in FIG. 6. In FIG. 6, the distal surface 26 comprises a plurality of separate spaces 44 extending part way up the handle 22 and a plurality of openings 46 extending between the separate spaces 44 and the exterior of the handle 22. In this embodiment, the particle remover must comprise a minimum of one separate space 44 and one opening 46.

Conclusion, Ramifications, and Scope

Accordingly, the reader will see that the particle remover of this invention can be used to quickly and easily remove particles of varying sizes, shapes and materials from a liquid.

Although the description above contains many specificities, these should not be construed as limiting the scope of the invention but as merely providing illustrations of some of the presently preferred embodiments of this invention. For example, the handle and elongated members can have other shapes, such as circular, oval, trapezoidal, triangular, etc.;

the distal surface can have other shapes such as concave, convex, etc.; the number and lengths of elongated members can be varied, etc.

Thus the scope of the invention should be determined by the appended claims and their legal equivalents, rather than by the examples given.

1. A particle removing tool for removing a particle from a liquid having a surface, said tool comprising members defining a chamber, said chamber having an axis substantially parallel to said members and having an end surface at one axial end of said chamber and an opening defined by said members at the axial end of said chamber remote from said one axial end, and a plurality of openings from said chamber position adjacent to said end surface so that when said tool is manipulated to move said chamber across said surface and into said liquid and around said particle, and said particle within said chamber adheres to at least one of said members and said end surface as said space is withdrawn from said liquid thereby to remove said particle in said space from said liquid.

2. A tool as defined in claim 1 further comprising a handle for said tool said handle having its longitudinal axis substantially parallel to said axis of said space.

3. A tool as defined in claim 1 further comprising a plurality of elongated members projecting from said surface toward said opening.

4. A tool as defined in claim 2 further comprising a plurality of elongated members projecting from said surface toward said opening.

5. A tool as defined in claim 1 wherein said chamber is divided into a plurality of separate spaces each having its axis substantially parallel to said axis of said chamber.

6. A tool as defined in claim 2 wherein said chamber is divided into a plurality of separate spaces each having its axis substantially parallel to said axis of said chamber.

7. A tool as defined in claim 3 wherein said chamber is divided into a plurality of separate spaces each having its axis substantially parallel to said axis of said chamber.

8. A tool as defined in claim 4 wherein said chamber is divided into a plurality of separate spaces each having its axis substantially parallel to said axis of said chamber.
